(19) United States
(12) Patent Application Publication
(10) Pub. No.: US 2005/0192200 A1
(43) Pub. Date: Sep. 1, 2005

(54) Liquid detergent composition comprising a solubilizing anionic surfactant

(76) Inventors: Stacie Ellen Hecht, West Chester, OH (US); Byong Koo Kim, Florence, KY (US); Jeffrey John Scheibel, Loveland, OH (US)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 11/098,339

(22) Filed: Apr. 4, 2005

Related U.S. Application Data
(63) Continuation-in-part of application No. 10/984,061, filed on Nov. 9, 2004.
(60) Provisional application No. 60/520,109, filed on Nov. 14, 2003.

(51) Int. Cl. C11D 17/00

(52) U.S. Cl. 510/426

(57) ABSTRACT

A liquid detergent composition comprising a limited amount of a solubilizing anionic surfactant for increased speed of cooked grease cleaning and methods of using the same.

### CROSS-REFERENCES

This application is a continuation-in-part and claims priority in part under 35 U.S.C. § 120 to U.S. Ser. No. 10/984,061 filed Nov. 9, 2004, which claims priority under 35 U.S.C. § 119(e) to U.S. provisional application No. 60/520,109, filed Nov. 14, 2004.

### FIELD OF INVENTION

The present invention relates to a liquid detergent composition comprising a limited amount of a solubilizing anionic surfactant for increased speed of cooked grease cleaning. The present invention also relates to light-duty liquid dishwashing detergent compositions and methods of using the same.

### BACKGROUND OF THE INVENTION

Increased grease cleaning for liquid detergents poses an ongoing problem for consumers. Grease cleaning may be classified in two forms: first, the total amount of grease cleaning or the grease suspending capacity: second, the speed of the grease cleaning or how fast grease is solubilized and removed from the desired surface. One approach to grease cleaning has been to improve the first form and to soak or allow surfaces to stand for a period of time before being cleaned. However, the second form of grease cleaning is also a desired trait of liquid detergents by consumers. The speed of grease cleaning is desired by consumers in liquid detergents as well as other visual indications of cleaning, such as suds profiles (high or low), feel, and smell. A balance of these desired traits in a liquid detergent remains an unsolved problem.

The second form of grease cleaning (speed of grease cleaning) requires the solubilization and removal of grease deposits from a surface. Grease deposits, particularly cooked grease deposits are difficult to solubilize and remove by the second form of grease cleaning. A cooked grease deposit, verses an uncooked grease deposit, comprises a higher viscosity grease deposit that resist solubilization and removal by liquid detergents. Oxidative degradation of grease when exposed to cooking heats forms polymerized triglycerides that lead to more viscous grease deposits that are comparatively more difficult to remove than uncooked grease deposits. It has been surprisingly found that to remove the cooked grease deposits, surfactants having higher solubility in grease are required. Identification of such surfactants may be accomplished using a hydrophile-lipophile balance number, otherwise known as an HLB number. Another measure to identify a suitable surfactant system for use in the present invention is the use critical micelle concentrations, otherwise known as CMC, which may be used to identify adequate hydrophobicity of a surfactant system.

Light-duty liquid dishwashing detergent compositions require a higher suds profile while providing not only the first form of grease cleaning but also the second form of grease cleaning. Additionally it has also surprisingly been found that the present invention gives improved speed of cooked grease cleaning while maintaining acceptable levels of total amount of grease cleaning and suds profile in a liquid dishwashing detergent composition.

### SUMMARY OF THE INVENTION

The present invention relates to a liquid detergent composition comprising a surfactant system comprising about 0.5% to about 5.0% of the liquid detergent composition of one or more solubilizing anionic surfactants comprising a hydrophile-lipophile balance number from about 8 to about 40.5.

The present invention further relates to a liquid detergent composition comprising a surfactant system comprising about 1.5% to about 4.5% of the liquid detergent composition of one or more solubilizing anionic surfactants comprising a hydrophile-lipophile balance number from about 10 to about 40.5, wherein the surfactant system has a critical micelle concentration (CMC) from about 12 to about 25 ppm.

The present invention further relates to a liquid detergent composition comprising a surfactant system comprising about 1.5 wt % to about 4.5 wt % of the liquid detergent composition of one or more solubilizing anionic surfactants comprising a hydrophile-lipophile balance number from about 10 to about 40.5, optionally an anionic surfactant other than the solubilizing anionic surfactant, an amine oxide surfactant, and a nonionic surfactant; wherein the surfactant system has a critical micelle concentration (CMC) from about 12 to about 25 ppm and from 30% to 95% by weight of the liquid detergent composition of a aqueous liquid carrier.

The present invention also relates to a method of washing dishes with the liquid detergent composition comprising the solubilizing anionic surfactant.

All documents cited are, in relevant part, incorporated herein by reference; the citation of any document is not to be construed as an admission that it is relevant art with respect to the present invention.

### DETAILED DESCRIPTION OF THE INVENTION

The liquid detergent compositions of the present invention surprising provide improved speed of cooked grease deposits. It has been found that inclusions of limited amounts of solubilizing anionic surfactants having an optimal hydrophile-lipophile balance number provide the benefit of improved speed of cooked grease cleaning. It has also been found that limited amounts of solubilizing anionic surfactants, when used in a surfactant system with a critical micelle concentration (CMC) from about 12 to about 25 ppm provide the benefit of improved speed of cooked grease cleaning. Additionally, the limited amounts of solubilizing anionic surfactant give the multiple benefits of increase speed of cooked grease cleaning while maintaining or exceeding acceptable levels of total amount of grease cleaning and suds profile in a liquid dishwashing detergent composition.

As used herein “grease” means materials comprising at least in part (at least 0.5 wt % by weight of the grease) unsaturated fats and oils, preferably oils and fats comprising linoleic and linolenic acids, more preferably oils and fats derived from vegetable sources comprising linoleic and linolenic acids.

As used herein “cooked grease” means grease exposed to increased temperatures in a standard oven, convection oven, toaster oven, microwave oven, stove top heating using a frying pan, wok, hot plate, electric griddle, or other known cooking appliances used to heat food during cooking.

As used herein “suds profile” means high sudsing and the persistence of sudsing throughout the washing process resulting from the use of the liquid detergent composition of the present invention. This is particularly important as the consumer uses high sudsing as an indicator of the performance of the liquid detergent composition. Moreover, the consumer also uses the sudsing profile as an indicator that the wash solution still contains active detergent ingredients usually renewing the wash solution when the sudsing subsides. Thus, a low sudsing formulation will tend to be replaced by the consumer more frequently than is necessary because of the low sudsing level.

As used herein “deposits” means cooked grease that are adhered to a surface, not limited in area or volume of cooked grease that is adhered to a surface such as dishes, glass, pots, pans, baking dishes, flatware or fabric.

As used herein “light-duty liquid dishwashing detergent composition” refers to those compositions that are employed in manual (i.e. hand) dishwashing. Such compositions are generally high sudsing or foaming in nature.

Incorporated and included herein, as if expressly written herein, are all ranges of numbers when written in a “from X to Y” or “from about X to about Y” format. It should be understood that every limit given throughout this specification will include every lower or higher limit, as the case may be, as if such lower or higher limit was expressly written herein. Every range given throughout this specification will include every narrower range that falls within such broader range, as if such narrower ranges were all expressly written herein.

Unless otherwise indicated, weight percentage is in reference to weight percentage of the liquid detergent composition. All temperatures, unless otherwise indicated are in Celsius.

Solubilizing Anionic Surfactants

It has surprisingly been found that limited amounts, from about 0.5% to about 5.0% by weight of the liquid detergent composition of one or more solubilizing anionic surfactants is suitable for the present invention. It has been surprisingly been found that the inclusion of less than about 0.5% and more than about 5.0%, by weight of the liquid detergent composition, of a solubilizing anionic surfactant does not demonstrate the desired speed in cooked grease cleaning as amounts of solubilizing anionic surfactant within the specified weight percentages. Solubilizing anionic surfactants that are suitable for use in the present invention are hydrophobic as determined by the solubilizing anionic surfactant's hydrophile-lipophile balance number (HLB number). The HLB of the solubilizing anionic surfactants are from about 8 to about 40.5, preferably about from about 10 to about 40. The HLB number may be found in standard references such as the Encyclopedia of Emulsion Technology, Vol 1, 1985, P. Becher, editor; McCutcheon's Emulsifiers and Detergents, or calculated in the following manner:
HLB=Σ(hydrophilic group numbers)−Σ(lipophilic group numbers)+7
See J. T Davies, Proceedings of the 2^{nd} International Congress of Surface Activity, vol. 1, London, 1957, pages 426-438.

Preferred solubilizing anionic surfactants for use in the present invention are selected from the group consisting of mid-chain branched alkylaryl sulfonate surfactant, mid-chain branched alkyl alkoxy sulfate surfactant, alcohol sulfate surfactant, oleoyl sarcosinate and mixtures thereof. More preferred solubilizing anionic surfactants for use in the present invention is selected from the group of C₁₂₋₁₃ mid-chain branched alkylaryl sulfonate surfactants, C₁₆₋₁₇ mid-chain branched alkyl alkoxy sulfate surfactants comprising an average of 0.01 to 10 alkoxy moieties per molecules, C₁₀₋₁₅ alcohol sulfate surfactants, and mixtures thereof. Further nonlimiting examples of solubilizing anionic surfactants for use in the present invention are shown in Table I below.

TABLE I

| Solubilizing Anionic Surfactant | HLB |
|---|---|
| C₁₂₋₁₃ alcohol sulfate such as C₁₂AS² | 40 |
| C₁₄₋₁₅ alcohol sulfate such as LIAL ® 145 | 38.8 |
| Sulfate from Sasol² | |
| C₁₆₋₁₇ mid-chain branched alcohol sulfate such as N67 HSAS² | 37.9 |
| C₁₆₋₁₇ mid-chain branched alcohol ethoxylated sulfate | 38.2 |
| EO = 1 such as El N67 HSAS² | |
| C₁₆₋₁₇ mid-chain branched alcohol ethoxylated sulfate | 38.9 |
| EO = 3 such as E3 N67 HSAS² | |
| C₁₆₋₁₇ mid-chain branched alcohol ethoxylated sulfate | 40.2 |
| EO = 7 such as E7 N67 HSAS² | |
| C₁₂₋₁₃ mid-chain branched alcohol propoxylated PO = 3 | 12.7 |
| sulfate such as SAFOL ® 23-3 from Sasol¹ | |
| C₁₄₋₁₅ mid-chain branched alcohol propoxylated PO = 1 | 9.0 |
| sulfate such as SAFOL ® 23-3 from Sasol¹ | |
| C₁₂₋₁₅ mid-chain branched alkylarylsulphonate MLAS² | 11.6 |
| Oleoyl sarcosinate such as Hamposyl ® O from Hampshire | 10 |
| Chemical¹ | |

¹Values from McCutcheon's Emulsifiers and Detergents
²Values calculated using method described in Proceedings of the 2nd International Congress of Surface Activity

The solubilizing anionic surfactant forms, at least part of, the surfactant system of the present invention. The surfactant system should have a critical micelle concentration (CMC) from about 10 to about 40.5 ppm, preferably from about 12 to about 21, more preferably from about 13.5 to about 20.2. The surfactant system of the present invention may comprise additional surfactants. Should additional surfactants be utilized, the CMC range should still be within the ranges specified above for the surfactant system. The CMC values may be determined according to the Critical Micelle Concentration Test Method described below.

Solubilizing anionic surfactants having suitable HLB numbers include a variety of mid-chain branched surfactants, indicated in Table I above as “SAFOL®”, “HSAS” and “MLAS”. As used herein “mid-chain branched” refers to surfactants, which generally comprise a hydrophobic and hydrophilic portion, having a hydrophobic portion wherein at least one C₁-C₄ alkyl and/or C₅-C₆ cycloalkyl branch is located on the hydrophobic portion as illustrated in formula (I) below which shows the desired mid-chain branching range (i.e., where points of branching occur), preferred mid-chain branching range, and more preferred mid-chain branching range for the hydrophobic portion of the anionic surfactant. Formula (I) shows a mid-chain branched alkyl sulfate surfactant.

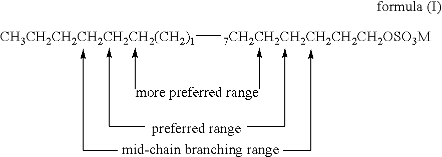

The solubilizing anionic mid-chain branched surfactant of the present invention comprises molecules having a linear primary alkyl chain backbone (i.e., the longest linear carbon chain which includes the sulfated carbon atom). These alkyl chain backbones comprise from 9 to 19 carbon atoms; and further the molecules comprise a branched primary alkyl moiety or moieties having at least about 1, but not more than 4 carbon atoms for a nalkyl branch and between 5 and 6 carbon atoms for a cycloalkyl branch.

The solubilizing anionic mid-chain branched surfactant referred to in Table I as “SAFOL®” and “HSAS” may comprise one or more mid-chain branched primary alkyl (polyoxyalkylene) sulfate surfactants having the formula (II): 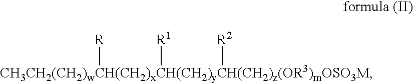
wherein for both the solubilizing anionic mid-chain branched alkyl sulfate and the alkyl alkoxy sulfate surfactants, R, R¹, and R² in formula (II) are each independently hydrogen, C₁-C₃ alkyl, C₅-C₆ cycloalkyl, and mixtures thereof; provided at least one of R, R¹, and R² in formula (II) is not hydrogen; preferably R, R¹, and R² in formula (II) are methyl; preferably one of R, R¹, and R² in formula (II) is methyl and the other units are hydrogen. The total number of carbon atoms in the mid-chain branched alkyl sulfate and alkyl alkoxy sulfate surfactants is from 14 to 20; the index w in formula (II) is an integer from 0 to 13; x in formula (II) is an integer from 0 to 13; y in formula (II) is an integer from 0 to 13; z in formula (II) is an integer of at least 1; provided the sum of w+x+y+z is from 8 to 14 and the total number of carbon atoms in a surfactant is from 14 to 20; R³ in formula (II), when present, is independently C₁-C₄ linear or branched alkylene, preferably ethylene, 1,2-propylene, 1,3-propylene, 1,2-butylene, 1,4-butylene, and mixtures thereof. R³ may be chosen to achieve a random or block arrangement of the (OR³)ₘ moiety. The average value of the index m in formula (II) is at least about 0.01 when alkoxylation is desired, if no alkoxylation is desired, then index m in formula (II) is 0 and a mid-chain branched alkyl sulfate surfactant is formed. Some tertiary carbon atoms may be present in the alkyl chain, however this embodiment is not desired.

M in formula (II) denotes a cation, preferably hydrogen, a water soluble cation, and mixtures thereof. Non-limiting examples of water soluble cations include sodium, potassium, lithium, ammonium, alkyl ammonium, and mixtures thereof.

The preferred solubilizing anionic mid-chain branched alkyl sulfate and alkyl alkoxy sulfate surfactants of the present invention are “substantially linear” surfactants. The term “substantially linear” is defined for the purposes of the present invention as “alkyl units which comprise one branching unit or the chemical reaction products which comprise mixtures of linear (non-branched) alkyl units and alkyl units which comprise one branching unit”. The term “chemical reaction products” refers to the admixture obtained by a process wherein substantially linear alkyl units are the desired product but nevertheless some non-branched alkyl units are formed. An admixture may comprise up to 50 wt % by weight of the admixture of linear alkyl units. When this definition is taken together with preferably one of R, R¹, and R² in formula (II) is methyl and/or C₅-C₆ cycloalkyl and the other units are hydrogen, the preferred mid-chain branched alkyl sulfate and alkyl alkoxy sulfate surfactants comprise one methyl branch, preferably said methyl branch is not on the α, β, e.g., the second to the last, carbon atom. Typically the branched chains are a mixture of isomers.

### Preparation of HSAS Mid-Chain Branched Alkoxylated Sulfates

The following reaction scheme outlines a general approach to the preparation of the HSAS solubilizing anionic mid-chain branched primary alcohol useful for optionally alkoxylating and then sulfating to prepare the HSAS solubilizing anionic mid-chain branched primary alkyl sulfate and alkoxylated sulfate surfactants of the present invention.

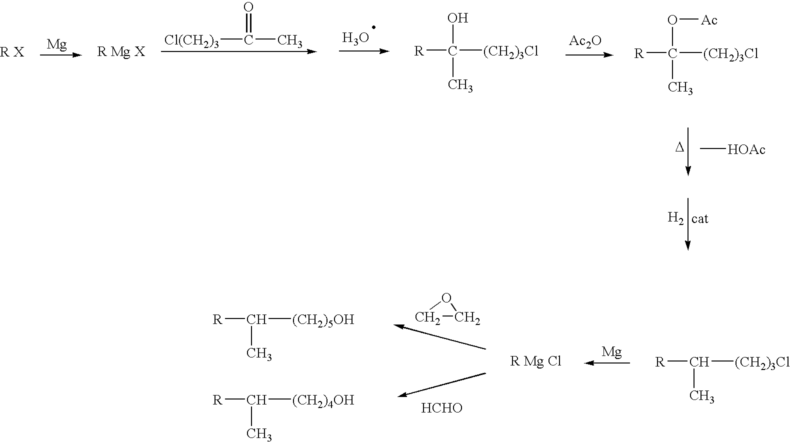

Note R in this reaction scheme represents at least a portion of the alkyl backbone of formulas (I) and (II). An alkyl halide is converted to a Grignard reagent and the Grignard is reacted with a haloketone. After conventional acid hydrolysis, acetylation and thermal elimination of acetic acid, an intermediate olefin is produced (not shown in the scheme) which is hydrogenated forthwith using any convenient hydrogenation catalyst such as Pd/C.

This route is favorable over others in that the branch, in this illustration a 5-methyl branch, is introduced early in the reaction sequence.

Formylation of the alkyl halide resulting from the first hydrogenation step yields alcohol product, as shown in the scheme. This can be alkoxylated using standard techniques and then sulfated using any convenient sulfating agent, e.g., chlorosulfonic acid, SO₃/air, or oleum, to yield the final branched primary alkyl alkoxylated sulfate surfactant. There is flexibility to extend the branching one additional carbon beyond that which is achieved by a single formylation. Such extension can, for example, be accomplished by reaction with ethylene oxide. See “Grignard Reactions of Nonmetallic Substances”, M. S. Kharasch and O. Reinmuth, Prentice-Hall, N.Y., 1954; J. Org. Chem., J. Cason and W. R. Winans, Vol. 15 (1950), pp 139-147; J. Org Chem., J. Cason et al., Vol. 13 (1948), pp 239-248; J. Org Chem., J. Cason et al., Vol. 14 (1949), pp 147-154; and J. Org Chem., J. Cason et al., Vol. 15 (1950), pp 135-138. See also U.S. Pat. No. 6,020,303; U.S. Pat. No. 6,060,443; and U.S. Pat. No. 6,008,181 for a further discussion on mid-chain branched alkyl sulfate and alkyl alkoxylated sulfate surfactants.

### EXAMPLE I

### Synthesis of Sodium 7-methylheptadecyl Ethoxylated (E1.5) Sulfate

1.A. Synthesis of (6-Hydroxyhexyl) Triphenylphosphonium Bromide

Add into a 5 L, 3 neck round bottom flask fitted with nitrogen inlet, condenser, thermometer, mechanical stirring and nitrogen outlet 6-bromo-1-hexanol (500 g, 2.76 mol), triphenylphosphine (768 g, 2.9 mol) and acetonitrile (1800 ml) under nitrogen. Heat the reaction mixture to reflux for 72 hrs. Cool the reaction mixture to room temperature (20° C.) and transferred into a 5 L beaker. Recyrstallize the product from anhydrous ethyl ether (1.5 L) at 10° C. Vacuum filtrate the mixture and then wash the recovered white crystals with ethyl ether. Dry in a vacuum oven at 50° C. for 2 hrs. The reaction gives 1140 g of the desired product.

1.B. Synthesis of 7-methylheptadecene-1-ol

Add into a dried 5 L, 3 neck round bottom flask fitted with mechanical stirring, nitrogen inlet, dropping funnel, thermometer and nitrogen outlet 80 g of 60% sodium hydride (2.0 mol) in mineral oil. Remove the mineral oil by washing with hexanes. Add anhydrous dimethyl sulfoxide (500 ml) to the flask and heat to 70° C. until evolution of hydrogen stops. Cool the reaction mixture to room temperature (20° C.) and then add 1 L of anhydrous tetrahydrofuran. Slurry (6-hydroxyhexyl) triphenylphosphonium bromide (443.4 g, 1 mol) with warm anhydrous dimethyl sulfoxide (50° C., 500 ml) and slowly add to the reaction mixture through the dropping funnel while keeping the reaction at 25-30° C. Stir the reaction for 30 minutes at room temperature (20° C.) at which time slowly add 2-dodecanone (184.3 g, 1.1 mol) through a dropping funnel. Reaction is slightly exothermic and cooling is needed to maintain 25-30° C. Stir the mixture for 18 hrs. and then pour into a separatory funnel containing 600 ml of purified water and 300 ml of hexanes. Shake and allow the oil phase (top) to separate out. Remove the water phase which is cloudy. Continue the extractions using water until the water phase and the organic phase become clear. Collect the organic phase and purify by liquid chromatography (mobile phase-hexanes, stationary phase-silica gel) to obtain a clear, oily product (116 g). HNMR of the final product (in deuterium oxide) indicates a CH₂—OSO₃⁻ triplet at the 3.8 ppm resonance, CH₂— CH₂— OSO₃⁻ multiplet at the 1.5 ppm resonance, CH₂ of the alkyl chain at the 0.9-1.3 ppm resonance and CH—CH₃ branch point overlapping the R—CH₂CH₃_{_{—}} terminal methyl group at the 0.8 ppm resonance.

1.C. Hydrogenation of 7-methylheptadecene-1-ol

Add into a 3 L rocking autoclave glass liner (Autoclave Engineers) 7-Methylheptadecene-1-ol (116 g, 0.433 mol), methanol (300 ml) and platinum on carbon (10% by weight, 40 g). Hydrogenate the mixture at 180° C. under 8.32 MPa (1200 psig) of hydrogen for 13 hrs, cool and vacuum filtered through CELITE® 545 with washing of CELITE® 545 with methylene chloride. Vacuum filter through CELITE® 545 and concentrate filtrate on a rotary evaporator to obtain a clear oil (108 g).

1.D. Alkoxylation of 7-methylpentadecanol

Add into a dried 1 L 3 neck round bottom flask fitted with a nitrogen inlet, mechanical stirrer, and a y-tube fitted with a thermometer and a gas outlet the alcohol from the preceeding step. For purposes of removing trace amounts of moisture, sparge the alcohol with nitrogen for about 30 minutes at 80-100° C. Continuing a nitrogen sweep, add sodium metal as the catalyst and allow to melt with stirring at 120-140° C. With vigorous stirring, add ethylene oxide gas in 140 minutes while keeping the reaction temperature at 120-140° C. After the correct weight (equal to 1.5 equivalents of ethylene oxide) has been added, sweep nitrogen through the apparatus for 20-30 minutes as the sample is allowed to cool. Then collect the desired 7-methylheptadecyl ethoxylate (average of 1.5 ethoxylates per molecule) product.

1.E. Sulfation of 7-methylheptadecyl ethoxylate (E1.5)

Add into a dried 1 L 3 neck round bottom flask fitted with a nitrogen inlet, dropping funnel, thermometer, mechanical stirring and nitrogen outlet chloroform and 7-methylheptadecyl ethoxylate (E1.5) from the preceeding step. Slowly add chlorosulfonic acid to the stirred mixture while maintaining 25-30° C. temperature with an ice bath. Once HCl evolution has stopped, slowly add sodium methoxide (25% in methanol) while keeping temperature at 25-30° C. until a aliquot at 5% concentration in water maintains a pH of 10.5. Add to the mixture hot methanol (45° C.) to dissolve the branched sulfate and follow immediately by vacuum filtration to remove the inorganic salt precipitate. Repeat the last step a second time. Cool the filtrate to 5° C. at which time add ethyl ether and let stand for 1 hour. Collect the precipitate by vacuum filtration to provide the desired 7-methylheptadecyl ethoxylate (average of 1.5 ethoxylates per molecule) sulfate, sodium salt, product.

The solubilizing anionic mid-chain branched surfactant referred to in Table I as “MLAS” may comprise at least one mid-chain branched alkylaryl sulphonate surfactant having formula (III): 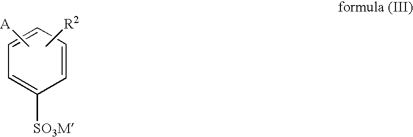
wherein A in formula (III) is a mid-chain branched alkyl unit having formula (IV): 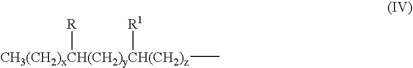
wherein R and R¹ in formula (IV) are each independently hydrogen, C₁-C₃ alkyl, and mixtures thereof, provided at least one of R and R¹ in formula (IV) is not hydrogen; preferably at least one R or R¹ in formula (IV) is methyl; wherein the total number of carbon atoms in said alkyl unit is from 6 to 18. Some tertiary carbon atoms may be present in the alkyl chain, however, this embodiment is not desired.

The integer x in formula (IV) is from 0 to 13. The integer y in formula (IV) is from 0 to 13. The integer z in formula (IV) is 0 or 1, preferably 0.

R² in formula (III) is hydrogen, C₁-C₃ alkyl, and mixtures thereof. Preferably R² in formula (III) is hydrogen.

M′ in formula (III) denotes a water soluble cation with sufficient charge to provide neutrality, preferably hydrogen, a water soluble cation, and mixtures thereof. Non-limiting examples of water soluble cations include sodium, potassium, lithium, ammonium, alkyl ammonium, and mixtures thereof.

In one embodiment of the present invention the solubilizing anionic mid-chain branched alkylaryl sulphonate surfactants are “substantially linear alkylaryl” surfactants. The term “substantially linear alkylaryl” is defined for the purposes of the present invention as “an alkyl unit which is taken together with an aryl unit wherein said alkyl unit preferably comprises one branching unit, however, a non-branched linear alkyl unit having an aryl unit bonded to the 2-carbon position as part of an admixture is included as a substantially linear alkylaryl surfactant”. The preferred alkyl units do not have a methyl branch on the second to the last carbon atom. Typically the branched chains are a mixture of isomers. However, in the case of the solubilizing anionic mid-chained branched alkylaryl sulphonate surfactants useful in the present invention, the relative position of the aryl moiety is key to the functionality of the surfactant. Preferably the aryl moiety is attached to the second carbon atom in the branched alkyl chain as illustrated herein below.

The solubilizing anionic mid-chain branched alkylaryl sulfonate surfactant may comprises two or more isomers with respect to positions of attachment of the benzyl ring of formula (III). In at least about 60%, preferably, 80%, more preferably, 100%, of the surfactant, the benzyl ring of formula (III) is attached to A of formula (III) in the position which is selected from positions alpha- and beta- to either of the two terminal carbon atoms of A of formula (III). The terms alpha- and beta-mean the carbon atoms which are one and two carbon atoms away, respectively, from the terminal carbon atoms. To better explain this, the structure below shows the two possible alpha-positions and the two possible beta-positions in a general linear hydrocarbon.

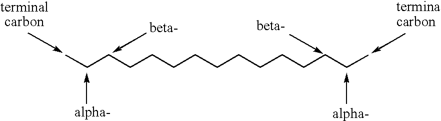

### EXAMPLE II

### Solubilizing Anionic Mid-Chain Branched alkylbenzenesulfonate Surfactant Prepared via Skeletally Isomerized Linear Olefin

Step (a): At Least Partially Reducing the Linearity of an Olefin (by Skeletal Isomerization of Olefin Preformed to Chainlengths Suitable for Cleaning Product Detergency)

Pass a mixture of 1-decene, 1-undecene, 1-dodecene and 1-tridecene (for example available from Chevron) at a weight ratio of 1:2:2:1 over a Pt-SAPO catalyst at 220° C. and any suitable LHSV, for example 1.0. The catalyst is prepared in the manner of Example 1 of U.S. Pat. No. 5,082,956. See WO 95/21225, e.g., Example 1 and the specification thereof. The product is a skeletally isomerized lightly branched olefin having a range of chainlengths suitable for making alkylbenezenesulfonate surfactant for consumer cleaning composition incorporation. More generally the temperature in this step can be from about 200° C. to about 400° C., preferably from about 230° C. to about 320° C. The pressure is typically from about 152 kPa (15 psig) to about 13.8 MPa (2000 psig), preferably from about 152 kPa (15 psig) to about 6.94 MPa (1000 psig), more preferably from about 152 kPa (15 psig) to about 4.19 MPa (600 psig). Hydrogen is a useful pressurizing gas for this step. The space velocity (LHSV or WHSV) is suitably from about 0.05 to about 20. Low pressure and low hourly space velocity provide improved selectivity, more isomerization and less cracking. Distill to remove any volatiles boiling at up to 40° C/1.33 kPa (10 mmHg).

Step (b): Alkylating the Product of Step (a) Using an Aromatic Hydrocarbon

Add to a glass autoclave liner 1 mole equivalent of the lightly branched olefin mixture produced in step (a), 20 mole equivalents of benzene and 20 wt % based on the olefin mixture of a shape selective zeolite catalyst (acidic mordenite catalyst ZEOCAT® FM-8/25H). Seal the glass liner inside a stainless steel rocking autoclave. Purge the autoclave twice with 1.77 MPa (250 psig) N₂ gas, and then charged to 6.94 MPa (1000 psig) N₂ gas. Mix and heat the mixture to 170-190° C. for 14-15 hours and then cool and remove from the autoclave. Filter the reaction mixture to remove catalyst and concentrate by distilling off unreacted starting-materials and/or impurities (i.e., benzene, olefin, paraffin, trace materials, with useful materials being recycled if desired) to obtain a clear near-colorless liquid product. The product formed is the a mid-chain branched alkylbenzene product which can, as an option, be shipped to a remote manufacturing facility where the additional steps of sulfonation can be accomplished.

Step (c): Sulfonating the Product of Step (b)

Sulfonate the mid-chain branched alkylbenzene product of step (b) with an equivalent of chlorosulfonic acid using methylene chloride as solvent. The methylene chloride is distilled away.

Step (d): Neutralizing the Product of Step (c)

Neutralize the product of step (c) is neutralized with sodium methoxide in methanol and the methanol evaporated to give improved alkylbenzenesulfonate surfactant. Further discussion on the production of such mid-chain branched alkyl benzene sulfonates may be found in WO 99/05243, WO 99/05242, WO 99/05244, WO 99/05082, WO 99/05084, WO 99/05241, WO 99/07656, WO 00/23549, and WO 00/23548.

Aqueous Liquid Carrier

The detergent compositions herein further contain from about 30% to 95% of an aqueous liquid carrier in which the other essential and optional compositions components are dissolved, dispersed or suspended. More preferably the aqueous liquid carrier will comprise from about 50% to 90% of the compositions herein.

One optional component of the aqueous liquid carrier is water. The aqueous liquid carrier, however, may contain other materials which are liquid, or which dissolve in the liquid carrier, at room temperature (20° C.) and which may also serve some other function besides that of inert filler. Such materials can include, for example, hydrotropes and solvents, discussed in more detail below. Dependent on the geography of use of the liquid detergent composition of the present invention, the water in the aqueous liquid carrier can have a hardness level of about 2-30 gpg (“gpg” is a measure of water hardness that is well known to those skilled in the art, and it stands for “grains per gallon”).

Surfactants

The liquid detergent composition of the present invention may further comprise a surfactant other than the solubilizing anionic surfactant selected from nonionic, anionic, cationic surfactants, ampholytic, zwitterionic, semi-polar nonionic surfactants such as amine oxide surfactants, and mixtures thereof. Optional surfactants, when present, may comprises from about 0.01% to about 50% by weight of the liquid detergent compositions of the present invention, preferably from about 1% to about 50 wt % by weight of the liquid detergent composition. Non-limiting examples of optional surfactants are discussed below.

Anionic Surfactants

Nonlimiting examples of optional anionic surfactants, other than the solubilizing anionic surfactant, useful herein include C₁₁-C₁₈ alkyl benzene sulfonates (LAS); C₁₀-C₂₀ primary and random alkyl sulfates (AS); C₁₀-C₁₈ secondary (2,3) alkyl sulfates C₁₀-C₁₈ alkyl alkoxy sulfates (AEₓS) wherein preferably x is from 1-30; C₁₀-C₁₈ alkyl alkoxy carboxylates preferably comprising 1-5 ethoxy units; methyl ester sulfonate (MES); and alpha-olefin sulfonate (AOS). Typically, when present, anionic surfactants may comprise from about 5% to about 50%, preferably from about 10% to 40% by weight of the liquid detergent composition.

Amine Oxide surfactants

Other surfactants that may be used in the liquid detergent composition of the present invention are amine oxide surfactants. Amine oxides surfactants, for optional use herein, include water-soluble amine oxides containing one alkyl moiety of from about 10 to about 18 carbon atoms and 2 moieties selected from the group consisting of alkyl groups and hydroxyalkyl groups containing from about 1 to about 3 carbon atoms; water-soluble phosphine oxides containing one alkyl moiety of from about 10 to about 18 carbon atoms and 2 moieties selected from the group consisting of alkyl groups and hydroxyalkyl groups containing from about 1 to about 3 carbon atoms; and water-soluble sulfoxides containing one alkyl moiety of from about 10 to about 18 carbon atoms and a moiety selected from the group consisting of alkyl and hydroxyalkyl moieties of from about 1 to about 3 carbon atoms.

Preferred amine oxide surfactants have formula (V): 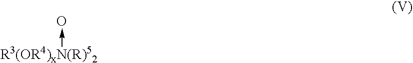
wherein R³ of formula (V) is an alkyl, hydroxyalkyl, alkyl phenyl group, and mixtures thereof; containing from about 8 to about 22 carbon atoms. R⁴ of formula (V) is an alkylene or hydroxyalkylene group containing from about 2 to about 3 carbon atoms or mixtures thereof. x of formula (V) is from 0 to about 3. Each R⁵ of formula (V) is an alkyl or hydroxyalkyl group containing from about 1 to about 3 carbon atoms or a polyethylene oxide group containing from about 1 to about 3 ethylene oxide groups. The R⁵ groups of formula (V) can be attached to each other, e.g., through an oxygen or nitrogen atom, to form a ring structure. These amine oxide surfactants in particular include C₁₀-C₁₈ alkyl dimethyl amine oxides and C₈-C₁₂ alkoxy ethyl dihydroxy ethyl amine oxides.

When present, an amine oxide surfactant will be present in the liquid detergent composition from at least about 0.1% to about 20%, more preferably at least about 0.2% to about 15%, even more preferably still, at least about 0.5% to about 10% by weight of the liquid detergent composition of amine oxide surfactant. Further examples of suitable amine oxide surfactants are given in “Surface Active Agents and Detergents” (Vol. I and II by Schwartz, Perry and Berch).

Nonionic Surfactants

Non-limiting examples of optional nonionic surfactants that may be used the present invention include C₁₂-C₁₈ alkyl alkoxylates, such as those derived from NEODOL® nonionic surfactants from Shell; SAFOL® and LIALET® nonionic surfactants from Sasol, and LUTENSOL® nonionic surfactants from BASF, preferred alkoxylation is ethoxylation with an average of 0.01 to 10 ethoxy units per molecule; C₆-C₁₂ alkyl phenol alkoxylates wherein the alkoxylate units are a mixture of ethyleneoxy and propyleneoxy units; C₁₂-C₁₈ alcohol and C₆-C₁₂ alkyl phenol condensates with ethylene oxide/propylene oxide block polymers such as PLURONIC® from BASF; C₁₄-C₂₂ mid-chain branched alcohols, as discussed in U.S. Pat. No. 6,150,322; C₁₄-C₂₂ mid-chain branched alkyl alkoxylates, BAEX, wherein x is from 1-30, as discussed in U.S. Pat. No. 6,153,577, U.S. Pat. No. 6,020,303 and U.S. Pat. No. 6,093,856; Alkylpolysaccharides as discussed in U.S. Pat. No. 4,565,647 Llenado, issued Jan. 26, 1986; specifically alkylpolyglycosides as discussed in U.S. Pat. No. 4,483,780 and U.S. Pat. No. 4,483,779; Polyhydroxy fatty acid amides (GS-base) as discussed in U.S. Pat. No. 5,332,528, WO 92/06162, WO 93/19146, WO 93/19038, and WO 94/09099; and ether capped poly(oxyalkylated) alcohol surfactants as discussed in U.S. Pat. No. 6,482,994 and WO 01/42408.

Typically, when present, nonionic surfactants that may be used in addition to the solublizing nonionic surfactants comprise from about 0.01% to about 20%, preferably from about 0.5% to about 10% by weight of the liquid detergent composition.

Zwitterionic Surfactants

Non-limiting examples of optional zwitterionic surfactants include: derivatives of secondary and tertiary amines, derivatives of heterocyclic secondary and tertiary amines, or derivatives of quaternary ammonium, quaternary phosphonium or tertiary sulfonium compounds. See U.S. Pat. No. 3,929,678 to Laughlin et al., issued Dec. 30, 1975 at column 19, line 38 through column 22, line 48, for examples of zwitterionic surfactants; betaine, including alkyl dimethyl betaine and cocodimethyl amidopropyl betaine, C₈ to C₁₈ (preferably C₁₂ to C₁₈) sulfo and hydroxy betaines, such as N-alkyl-N,N-dimethylammino-1-propane sulfonate where the alkyl group can be C₈ to C₁₈, preferably C₁₀ to C₁₄. Typically, when present, zwitterionic surfactants comprise from about 0.01% to about 20%, preferably from about 0.5% to about 10% by weight of the liquid detergent composition.

Calcium and/or Magnesium Ions

The presence of calcium and/or magnesium (divalent) ions are utilized to improve the overall cleaning of greasy soils for light-duty liquid detergent compositions. This is especially true when the light-duty liquid detergent compositions are used in softened water that contains few divalent ions. It is believed that calcium and/or magnesium ions increase the packing of the surfactants at the oil/water interface, thereby reducing interfacial tension and improving overall grease cleaning.

Preferably, the magnesium or calcium ions are added as a hydroxide, chloride, acetate, formate, oxide or nitrate salt to the liquid detergent compositions of the present invention. Calcium ions may also be added as salts of the hydrotrope. Calcium and/or magnesium ions may also be formulated into the light-duty liquid detergent composition as a salt of a surfactant such as that described in U.S. Pat. No. 6,506,719, Arvanitidou, et al.

The liquid detergent compositions of the invention may contain magnesium and/or calcium ions and be present in the liquid detergent compositions herein at an active level of from about 0.1% to about 4%, preferably from about 0.1% to about 3.5%, more preferably from about 0.2% to about 1%, by weight of the liquid detergent composition.

Solvent:

The liquid detergent compositions of the invention may comprise a solvent in an effective amount so as to reach the desired viscosity of greater than 700 cps, when measured at 20° C. More preferably the viscosity of the composition is between 700 and 1100 cps. Suitable solvents for use herein include low molecular weight alcohols such as C₁-C₁₀, preferably C₁-C₄ mono- and dihydric alcohols, preferably ethyl alcohol, isopropyl alcohol, propylene glycol and hexylene glycol. The compositions herein typically comprise from 0.1% to 20%, preferably 0.5% to 15%, most preferably 1% to 5%, by weight of the liquid detergent composition of a solvent.

Viscosity Test Method

The viscosity of the composition of the present invention is measured on a Brookfield viscometer model # LVDVII+ at 20° C. The spindle used for these measurements is S31 with the appropriate speed to measure products of different viscosities; e.g., 12 rpm to measure products of viscosity greater than 1000 cps; 30 rpm to measure products with viscosities between 500 cps-1000 cps; 60 rpm to measure products with viscosities less than 500 cps.

Hydrotrope:

The liquid detergent compositions of the invention may comprise a hydrotrope. Suitable hydrotropes for use herein include anionic-type hydrotropes, particularly sodium, potassium, and ammonium xylene sulfonate, sodium, potassium and ammonium toluene sulfonate, sodium potassium and ammonium cumene sulfonate, and mixtures thereof, and related compounds (as disclosed in U.S. Pat. No. 3,915,903).

The liquid detergent compositions of the present invention typically comprise from 0% to 15% by weight of the liquid detergent composition of a hydrotropic, or mixtures thereof, preferably from 1% to 10%, most preferably from 3% to 6%.

Thickening Agent

The liquid detergent compositions herein can also contain from about 0.2% to 5% by weight of the liquid detergent composition of a thickening agent. More preferably, such a thickening agent will comprise from about 0.5% to 2.5% of the liquid detergent compositions herein. Thickening agent are typically selected from the class of cellulose derivatives. Suitable thickeners include hydroxy ethyl cellulose, hydroxyethyl methyl cellulose, carboxy methyl cellulose, QUATRISOFT® LM200, and the like. A preferred thickening agent is hydroxypropyl methylcellulose.

Suds Boosters

The liquid detergent compositions herein can also contain from about 0.05% to 5% by weight of the liquid detergent composition of a suds booster. Suds boosters are utilized for increased suds volume and increased suds retention while washing, especially by hand, dishware. These polymeric suds stabilizers may be selected from homopolymers of (N,N-dialkylamino) alkyl esters and (N,N-dialkylamino) alkyl acrylate esters. The weight average molecular weight of the polymeric suds boosters, determined via conventional gel permeation chromatography, is from 1,000 to 2,000,000, preferably from 5,000 to 1,000,000, more preferably from 10,000 to 750,000, more preferably from 20,000 to 500,000, even more preferably from 35,000 to 200,000. The polymeric suds stabilizer can optionally be present in the form of a salt, either an inorganic or organic salt, for example the citrate, sulfate, or nitrate salt of (N,N-dimethylamino)alkyl acrylate ester.

One preferred polymeric suds stabilizer is (N,N-dimethylamino)alkyl acrylate esters, namely the acrylate ester represented by the formula (VI):

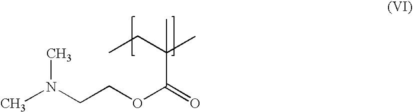

When present in the compositions, the polymeric suds booster may be present in the composition from 0.01% to 15%, preferably from 0.05% to 10%, more preferably from 0.1% to 5%, by weight. Examples of other suitable suds boosters are discussed in U.S. Pat. No. 6,207,631, U.S. Pat. No. 6,369,012, U.S. Pat. No. 6,372,708, U.S. Pat. No. 6,528,477, EP 1 223 212, and U.S. Pat. No. 6,645,925 B1.

Other Optional Components:

The liquid detergent compositions herein can further comprise a number of other optional ingredients suitable for use in liquid detergent compositions such as perfume, dyes, opacifiers, enzymes, builders, chelants, and pH buffering means so that the liquid detergent compositions herein generally have a pH of from 5 to 11, preferably 6 to 11, most preferably 7 to 11. A further discussion of acceptable optional ingredients suitable for use in liquid detergent compositions, specifically light-duty liquid detergent composition may be found in U.S. Pat. No. 5,798,505.

Preferably, the liquid detergent compositions herein are formulated as clear liquid compositions. By “clear” it is meant stable and transparent. In order to achieve clear compositions, the use of solvents and hydrotropes is well known to those familiar with the art of light-duty liquid dishwashing compositions. Preferred liquid detergent compositions in accordance with the invention are clear single phase liquids, but the invention also embraces clear and opaque products containing dispersed phases, such as beads or pearls as described in U.S. Pat. No. 5,866,529, to Erilli, et al., and U.S. Pat. No. 6,380,150, to Toussaint, et al., provided that such products are physically stable (i.e., do not separate) on storage.

The liquid detergent compositions of the present invention may be packages in any suitable packaging for delivering the liquid detergent composition for use. Preferably the package is a clear package made of glass or plastic.

Method of Use

The present invention includes a method for cleaning a targeted surface. As used herein “targeted surface” may include such surfaces such as dishes, glasses, and other cooking surfaces. Such method includes the steps of contacting the composition comprising the solubilizing anionic surfactant, in neat form or diluted in wash liquor, with at least a portion of a targeted surface then optionally rinsing the targeted surface. Preferably the targeted surface is subjected to a washing step prior to the aforementioned optional rinsing step. For purposes of the present invention, washing includes but is not limited to, scrubbing, and mechanical agitation.

As will be appreciated by one skilled in the art, the cleaning compositions of the present invention are ideally suited for use in liquid dish cleaning compositions. The method for using a liquid dish composition of the present invention comprises the steps of contacting soiled dishes with an effective amount, typically from about 0.5 ml. to about 20 ml. (per 25 dishes being treated) of the liquid dish cleaning composition of the present invention diluted in water.

Test Methods

Cooked Grease Screening Method

Pre-weigh a steel metal slide and record the weight. Melt a soil sample of 100 g of CRISCO® shortening from the J. M. Smuckers Company, in an 237 mL (8 fluid ounce (US)) glass jar for 2 minutes in a microwave (high setting ˜1350 W). Place 0.7 g to about 0.8 g of melted soil on the metal slide using a pipette and then cook the metal slide with soil for 30 minutes at 194° C. (381° F.) in a standard oven, such as the Thelco Laboratory Oven, Precision Model 31619. Allow the metal plate to cool to room temperature (20° C.). Weigh the metal slide to determine the cooked soil weight. Prepare a solution of 2100 mL of deionized water adjusted to a 15 gpg hardness and 100 ppm bicarbonate. Heat the soulution to 48.9° C. (120° F.). Add the detergent formulation shown in Table II below, to make a 2600 ppm detergent solution. In a TEFLON® jar of 473 mL (16 fluid oz (US)) add 200 mL of the prepared detergent solution and allow the detergent solution to cool to a temperature of 46.1° C. (115° F.). Add the metal plate to the 46.1° C. (115° F.) detergent solution and soak for 2 minutes. Remove the metal plate from the detergent solution to dry for 12 to 14 hours at room temperature (25° C.) and weigh to determine the amount of cooked grease removed.

Critical Micelle Concentration Test

To test the critical micelle concentration of the surfactant system, the Wilhemy Plate method may be used at room temperature (25° C.) at a pH of 8 used with a water solution with a 7 gpg hardness level and sodium bicarbonate. Testing may use a Kruss K-100 Tensiometer. See also Elaine N. B. Stasiuk and Laurier L. Schramm, “The Temperature Dependence Of Critical Micelle Concentrations Of Foam-Forming Surfactants” Journal of Colloid and Interface Science, 178, 324-333 (1996), for a general discussion of CMC values.

Formulations

TABLE II

| | Formula 1 | Formula 2 | Formula 3 | Formula 4 | Formula 5 | Formula 6 |
|---|---|---|---|---|---|---|
| C₁₂₋₁₃ alcohol ethoxylate | 26 | 26 | 23 | 24 | 26 | 23 |
| sulfate EO = 0.6 | | | | | | |
| Amine Oxide | 5.8 | 5.8 | 5.8 | 5.8 | 5.8 | 6.5 |
| C₈₋₁₂ alcohol ethoxylate | 2 | 2 | 2 | 2 | 2 | 2 |
| EO = 8 | | | | | | |
| C₁₂₋₁₃ MLAS¹ | — | 3 | — | — | — | 0 |
| C₁₆₋₁₇ mid-chain | — | — | 3 | — | — | 0 |
| branched alcohol | | | | | | |
| ethoxylate sulfate | | | | | | |
| EO = 3² | | | | | | |
| C₁₆₋₁₇ mid-chain | — | — | — | 2 | — | 0 |
| branched alcohol | | | | | | |
| ethoxylate sulfate | | | | | | |
| EO = 7² | | | | | | |
| C₁₂₋₁₃ alcohol | | | | | | |
| propoxylate PO = 3 | | | | | | |
| Sulfate | | | | | | |
| C₁₄₋₁₅ alcohol sulfate³ | — | — | — | — | 3 | 0 |
| Ethanol | 2 | 2 | 2 | 2 | 2 | 2 |
| Sodium cumene | 1.80 | 1.80 | 1.80 | 1.80 | 1.80 | 1.8 |
| sulfonate | | | | | | |
| NaCl | 1.4 | 1.4 | 1.4 | 1.4 | 1.4 | 1.4 |
| MgCl₂ | 0.2 | 0.2 | 0.2 | 0.2 | 0.2 | 0.2 |
| Suds Booster⁴ | 0.2 | 0.2 | 0.2 | 0.2 | 0.2 | 0.2 |
| Poly propylene glycol | 0.8 | 0.8 | 0.8 | 0.8 | 0.8 | 0.8 |
| M_{w} = 2000⁵ | | | | | | |
| Water & other trace | To | To | To | To | To | To |
| components (i.e., dye, | 100% | 100% | 100% | 100% | 100% | 100% |
| perfume, diamine, etc.) | | | | | | |
| CMC, in ppm | 32.0 | 19.9 | 17.6 | 20.2 | 17.9 | |

Please note that EO represents ethoxylate moieties and PO represents propoxylate moieties in the indicated surfactant.
¹as described herein above; See also WO 99/05243, WO 99/05242, WO 99/05244, WO 99/05082, WO 99/05084, WO 99/05241, WO 99/07656, WO 00/23549, and WO 00/23548.
²as described herein above; See also U.S. Pat. No. 6,020,303; U.S. Pat. No. 6,060,443; and U.S. Pat. No. 6,008,181.
³available as LIAL ® 145 Sulfate from Sasol
⁴as described in formula (VI) or in U.S. Pat. No. 6,645,925 B1
⁵such as P2000E (PPG-26) available from Dow Chemicals or PLURACOL ® P 2000 available from BASF.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A liquid detergent composition comprising a surfactant system comprising about 0.5% to about 5.0% of the liquid detergent composition of one or more solubilizing anionic surfactants comprising a hydrophile-lipophile balance number from about 8 to about 40.5.

2. The liquid detergent composition according to claim 1 wherein the surfactant system has a CMC from about 12 to about 25.

3. The liquid detergent composition according to claim 1 wherein the solubilizing anionic surfactant is selected from the group consisting of mid-chain branched alkylaryl sulfonate surfactant, mid-chain branched alkyl alkoxy sulfate surfactant, alcohol sulfate surfactant, oleoyl sarcosinate and mixtures thereof.

4. The liquid detergent composition of claim 1 further comprising from 30% to 95% by weight of the liquid detergent composition of an aqueous liquid carrier; and the surfactant system further comprising from 5% to about 50% by weight of the liquid detergent composition of a anionic surfactant other than a solubilizing anionic surfactant; Optionally from about 0% to about 20% by weight of the liquid detergent composition of an amine oxide; Optionally from about 0% to about 20% by weight of the liquid detergent composition of a nonionic surfactant.

5. The liquid detergent composition according to claim 1 wherein the nonionic surfactant selected from the group of C₁₂-C₁₈ alkyl alkoxylate surfactants, C₁₄-C₂₂ mid-chain branched alcohol surfactants, C₁₄-C₂₂ mid-chain branched alkyl alkoxylates surfactants, and mixtures thereof.

6. The liquid detergent composition according to claim 1 wherein the surfactant system further comprises an amine oxide having the formula: 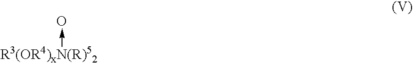
wherein R³ of formula (V) is an alkyl, hydroxyalkyl, or alkyl phenyl group or mixtures thereof containing from about 8 to about 22 carbon atoms; R⁴ of formula (V) is an alkylene or hydroxyalkylene group containing from about 2 to about 3 carbon atoms or mixtures thereof; x is from 0 to about 3; and each R⁵ of formula (V) is an alkyl or hydroxyalkyl group containing from about 1 to about 3 carbon atoms or a polyethylene oxide group containing from about 1 to about 3 ethylene oxide groups.

7. The liquid detergent composition according to claim 4 wherein the anionic surfactant other than the solubilizing anionic surfactant is selected from the group of C₁₁-C₁₈ alkyl benzene sulfonates, C₁₀-C₂₀ primary and random alkyl sulfates, C₁₀-C₁₈ alkyl alkoxy sulfates, and mixtures thereof.

8. The liquid detergent composition according to claim 2 further comprising from 0.1% to 4% by weight of the liquid detergent composition of magnesium ions, calcium ions, and any mixture thereof.

9. The liquid detergent composition according to claim 1 wherein the liquid detergent composition is a clear liquid.

10. The use of the composition of claim 1 wherein the use comprises the step of contacting the composition with a targeted surface.
